(19) United States
(12) Patent Application Publication
(10) Pub. No.: US 2022/0131184 A1
(43) Pub. Date: Apr. 28, 2022

(54) AIR-STABLE SOLID-STATE SULFIDE ELECTROLYTE

(71) Applicant: Battelle Memorial Institute, Richland, WA (US)

(72) Inventors: Zhaoxin Yu, Richland, WA (US); Dongping Lu, Richland, WA (US); Jie Xiao, Richland, WA (US); Jun Liu, Richland, WA (US)

(73) Assignee: Battelle Memorial Institute, Richland, WA (US)

(21) Appl. No.: 17/507,432

(22) Filed: Oct. 21, 2021

Related U.S. Application Data
(60) Provisional application No. 63/104,718, filed on Oct. 23, 2020.

(51) Int. Cl. H01M 10/0562

(52) U.S. Cl. CPC H01M 10/0562; H01M 2300/0068

(57) ABSTRACT

A method that includes contacting an amphipathic surface protective agent with a moisture sensitive Li-ion conductor material surface resulting in a protected Li-ion conductor material, and assembling an electrochemical cell that includes the protected Li-ion conductor material.

This application claims the benefit of U.S. Provisional Application No. 63/104,718 filed on Oct. 23, 2020, which is incorporated herewith in its entirety.

### ACKNOWLEDGMENT OF GOVERNMENT SUPPORT

This invention was made with government support under Contract DE-AC0576RL01830 awarded by the U.S. Department of Energy. The government has certain rights in the invention.

### BACKGROUND

Lithium-ion batteries (LIBs) have been widely used in our daily life, especially in portable electronics like cell phones and personal computers. In recent years, LIBs have also been adopted as power sources in electrical vehicles (EVs), which greatly expands the portion of LIBs in the energy storage market. With EVs market being expected to further grow by 50% by 2030, demand for new generation of LIBs with higher energy/power density and superior safety features becomes urgent. However, safety concerns rise associating with increase of cell energy density, mainly because of organic liquid electrolytes (OLEs) possessing intrinsically high flammability, great volatility, and radical reactivity in contact with oxidative or reductive electrode materials. Compared to LIBs or lithium metal batteries (LMBs) using OLEs, adoption of inflammable inorganic solid-state electrolytes (SSEs) in all-solid-state batteries (ASSBs) could fundamentally eliminate safety concerns.

High performance solid-state electrolytes (SSEs), such as sulfides, oxides, and polymer- based electrolytes, are crucial to the success of ASSBs with high energy and power density. Among these SSEs, sulfides are believed to be more promising because of their soft nature and high ionic conductivities at room temperature, both of which ensure good SSE/electrode materials contact and fast Li-ion conduction. However, poor moisture stability of sulfide SSEs associated with generation of highly toxic H₂S gas hinders their evaluation and application at practical scale. To address this critical issue, several strategies have been previously tried.

One is to combine inorganic H₂S absorption additives (such as Fe₂O₃, ZnO, and Bi₂O₃) into SSEs to chemically consume the generated H₂S gas. Even though the amount of H₂S releasing from SSE can be lowered to some extent, overall Li-ion conductivity was hugely reduced due to the existence of H₂S releasing reactions and non-conductive nature of these additives. Another strategy is focused on developing sulfide SSEs with intrinsically good moisture stability based on the hard/soft acidbase (HSAB) theory. Specifically, relatively soft acids such as Cu^{I}, Ge^{IV}, and As^{V} prefer to bond soft bases such as S²⁻, forming strong covalent bonds and a rigid framework. Guided by the HSAB theory, quaternary sulfides such as Li_{3.833}Sn_{0.833}AS_{0.166}S₄ and Li₄Cu₈Ge₃S₁₂ have been developed, which exhibited improved moisture stability. However, these sulfide-containing SSEs (including Li₁₀GeP₂S₁₂ and Li₁₀SnP₂S₁₂ as well) suffer from poor chemical/electrochemical stability against Li metal anode, where SSEs are reduced into electronically conductive Li-metal alloys (LiGeₓ and LiSnₓ), shorting the cell ultimately. Moreover, those “heavy metal” contained SSEs usually involves high temperature synthesis and penalties of high materials density. In addition, existing solid state sulfide electrolytes suffer from poor air stability, which makes it hard to produce materials in an ambient air environment.

### SUMMARY

One embodiment disclosed herein is a method comprising:

contacting an amphipathic surface protective agent with a moisture sensitive Li-ion conductor material surface resulting in a protected Li-ion conductor material, and

assembling an electrochemical cell that includes the protected Li-ion conductor material.

Another embodiment disclosed herein is a method comprising:

coating an amphipathic surface protective agent onto a surface of a sulfide-containing solid-state electrolyte material.

Another embodiment disclosed herein is a material comprising a sulfide-containing solid-state electrolyte coated with an amphipathic surface protective agent, wherein the amphipathic surface protective agent includes a hydrophilic head selected from —OH; —C(O)O—; —C═O—; —NH—; —Alₙ(OH)ₘ, wherein n≥1 and m≥1; —PO₄—; —C(O)NH₂; —NH₂; —OSO₃H; —SO₃H; —SH; —Cl; —Br; —I; and —NR₄⁺, wherein R is CₓH₂ₓ₊₁, x≥1; and a hydrophobic tail selected from —CH₃; —CH₂—CH₃; —R—C₆H₅, wherein R is CₓH₂ₓ₊₁, x≥1; —CH═CH₂; -C₃-C₅₀ alkyl or substituted alkyl; -C₃-C₅₀ alkenyl or substituted alkenyl; -C₃-C₅₀ alkynyl or substituted alkynyl; (CH₂)ₙ(n≥2); —CH₂F; —CHF₂; —CF₃; (CF₂)ₙ(n≥2); and (Si(CH₃)₂—O—)ₙ(n≥2).

An additional embodiment disclosed herein is a construct comprising:

a sulfide-containing solid-state electrolyte coated with an amphipathic surface protective agent, wherein the amphipathic surface protective agent includes a hydrophilic head selected from —OH; —C(O)O—; —C═O—; —NH—; —Alₙ(OH)ₘ, wherein n≥1 and m≥1; —PO₄—; —C(O)NH₂; —NH₂; —OSO₃H; —SO₃H; —SH; —Cl; —Br; —I; and —NR₄⁺, wherein R is CₓH₂ₓ₊₁, x≥1; and a hydrophobic tail selected from —CH₃; —CH₂—CH₃; —R—C₆H₅, wherein R is CₓH₂ₓ₊₁, x≥1; —CH═CH₂; -C₃-C₅₀ alkyl or substituted alkyl; -C₃-C₅₀ alkenyl or substituted alkenyl; -C₃-C₅₀ alkynyl or substituted alkynyl; (CH₂)ₙ(n≥2); —CH₂F; —CHF₂; —CF₃; (CF₂)ₙ(n≥2); and (Si(CH₃)₂—O—)ₙ(n≥2);

a cathode material; and

an anode material.

The foregoing will become more apparent from the following detailed description, which proceeds with reference to the accompanying figures.

### BRIEF DESCRIPTION OF THE DRAWINGS

FIG. 1 is a schematic illustration of reversible coating and releasing of 1-Bromopentane on/from SSE.

FIGS. 2A-2C. Reversible chemical treatment of SSE with 1-Bromopentane. FIG. 2A, High-resolution C 1 s spectra, FIG. 2B, atomic concentrations of Br and C, and FIG. 2C, electrochemical impedance spectra of pristine LPSBI, LPSBI-Bromo, and LPSBI-Bromo-160 samples.

FIGS. 3A-3D. Promising moisture stability of LPSBI-Bromo. FIG. 3A, FIG. 3B, H₂S generation of Li₇P₂S₈Br_{0.5}I_{0.5} powders with/without 1-Bromopentane exposed to air with relative humidity of 0.1% (in dry room) (FIG. 3A) and 20% (FIG. 3B). FIG. 3C, FIG. 3D, Electrochemical Impedance spectra of pristine LPSBI (FIG. 3C) and LPSBI-Bromo (FIG. 3D) before and after exposure to air with relative humidity of 20% at room temperature.

FIGS. 4A-4C. Spectroscopic characterizations to identify surface changes in SSEs after air exposure. a, b, c, High-resolution C 1 s spectra (FIG. 4A), atomic concentrations of Br, O and C (FIG. 4B), and Raman spectra (FIG. 4C) of pristine LPSBI, LPSBI-20%, LPSBI-Bromo, and LPSBI-Bromo-20% samples.

FIG. 5 is a graph showing H₂S generation of Li₆PS₅Cl powders with/without 1-Bromopentane exposed to air with relative humidity of 10%.

FIG. 6 is a graph showing H₂S generation of Li₃PS₄ powders with/without 1-Bromopentane exposed to air with relative humidity of 49%.

### DETAILED DESCRIPTION

### Definitions

Anode: An electrode through which electric charge flows into a polarized electrical device. From an electrochemical point of view, negatively-charged anions move toward the anode and/or positively-charged cations move away from it to balance the electrons leaving via external circuitry.

Cathode: An electrode through which electric charge flows out of a polarized electrical device. From an electrochemical point of view, positively charged cations invariably move toward the cathode and/or negatively charged anions move away from it to balance the electrons arriving from external circuitry.

Electrochemical cell: As used herein, a cell refers to an electrochemical device used for generating a voltage or current from a chemical reaction, or the reverse in which a chemical reaction is induced by a current. Examples include voltaic cells, electrolytic cells, and fuel cells, among others. A battery includes one or more cells. The terms “cell” and “battery” are used interchangeably when referring to a battery containing only one cell.

Electrolyte: A substance containing free ions that behaves as an electrically conductive medium.

Microparticle: As used herein, the term “microparticle” refers to a particle with a size measured in microns, such as a particle with a diameter of 1-100 μm.

Nanoparticle: As used herein, the term “nanoparticle” particle that has a size measured in nanometers, such as a particle with a diameter of 1-100 nm.

Separator: A battery separator is a porous sheet or film placed between the anode and cathode. It prevents physical contact between the anode and cathode while facilitating ionic transport.

### SSE Surface Protection

The methods and materials disclosed herein improve the processability as well as lower the cost associated with electrolyte production and cell fabrication. Disclosed herein is a novel surface protection strategy for moisture sensitive sulfide SSEs. By employing amphipathic compound(s) as a surface protection agent, an ultra-thin and effective layer can be constructed on the surface of an SSE via Van der Waals force interaction. A singe amphipathic compound or a mixture or amphipathic compounds can be used. The SSE can be in the form of particles, films, or other shapes.

The amphipathic compound includes at least one hydrophilic head and at least one hydrophobic tail. The hydrophilic head is anchored on the surface of the SSE via Van der Waals force, forming an ultra-thin layer of protecting interphase; the hydrophobic tail shields sulfide SSE surface from water molecules attacking the SSE surface. There are several advantages of such an amphipathic interphase. First, molecules with hydrophilic heads are physically attached on sulfides' surface, forming very thin protection layers, which has very limited impact on the bulk properties of the SSEs. Second, chemical composition and structure of this protection layer can be tuned through the design or selection of appropriate functional groups depending on the structures/surface properties of the target SSE. Third, the protection layer can be released by heat treatment due to weak interaction force between the protection layer and SSE, bringing ionic conductivity back to the original value, which is desirable in practical application and processing.

In certain embodiments, the surface protective agent has a boiling point lower than the synthesis temperature of the SSE.

The protected air-stable sulfide-containing SSEs facilitate synthesis, storage, transfer, and processing of solid electrolytes and fabrication of solid-state lithium batteries in an ambient environment. The protected SSEs are stable with O₂, CO₂ and N₂ in the air and also stable against water with very limited generation of H₂S (<10 ppm within 2 hours) in the air (relative humidity <15%). The outstanding air stability of the protected SSEs significantly improves processability of the materials for the cell manufacturer and this hugely reduces the cost of the processing. In addition, the developed air-stable solid-state electrolytes provide superior lithium-ion conductivity.

Illustrative moieties that can serve as hydrophilic heads include —OH; —C(O)O—; —C═O—; —NH—; —Alₙ(OH)ₘ, wherein n≥1 and m≥1; —PO₄—; —C(O)NH₂; —NH₂; —OSO₃H; —SO₃H; —SH; —Cl; —Br; —I; and —NR₄⁺, wherein R is CₓH₂ₓ₊₁, x≥1.

Illustrative moieties that can serve as hydrophobic tails include —CH₃; —CH₂—CH₃; —R—C₆H₅, wherein R is CₓH₂ₓ₊₁, x≥1; —CH═CH₂; -C₃-C₅₀ alkyl or substituted alkyl; -C₃-C₅₀ alkenyl or substituted alkenyl; -C₃-C₅₀ alkynyl or substituted alkynyl; (CH₂)ₙ(n≥2); —CH₂F; —CHF₂; —CF₃; (CF₂)ₙ(n≥2); and (Si(CH₃)₂—O—)ₙ(n≥2).

Illustrative amphipathic compounds that could function as surface protection agents include:

CₓH₂ₓ₊₁Br (x≥1): For example, 2-Bromopentane, 3-Bromopentane, 1-Bromo-3-methylbutane, 1-Bromo-2-methylbutane, 1-Bromo-2,2-dimethylpropane, 2-Bromo-2-methylbutane, 1-Bromobutane, 1-Bromohexane, and 1-Bromooctane
CₓH₂ₓ₊₁Cl (x≥1): For example, 1-Chloropentane, 2-Chloropentane, 3-Chloropentane, 1-Chloro-3-methylbutane, 1-Chloro-2-methylbutane, 1-Chloro-2,2-dimethylpropane, 2-Chloro-2-methylbutane, 1-Chlorobutane, 1-Chlorohexane, and 1-Chlorooctane
CₓH₂ₓ₊₁I (x≥1): For example, 1-Iodopentane, 2-Iodopentane, 3-Iodopentane, 1-Iodo-3-methylbutane, 1-Iodo-2-methylbutane, 1-Iodo-2,2-dimethylpropane, 2-Iodo-2-methylbutane, 1-Iodobutane, 1-Iodohexane, and 1-Iodooctane
CₓH₂ₓ₊₁SH (x≥1): For example, 1-Butanethiol, 2-Methyl-1-butanethiol, 3-Methyl-1-butanethiol, 4-Methoxy-2-methyl-2-butanethiol, 1-Propanethiol, 2-Propanethiol, 2-Methyl-1-propanethiol, 1-Hexanethiol, 1-Octanethiol, 1-Dodecanethiol
Ether R¹OR², wherein, R¹ and R² are each independently CₓH₂ₓ₊₁(x≥1): For example, Diethyl Ether, Isoamyl ether, Dibutyl ether, Dipentyl ether, Diisopropyl ether, Dipropyl ether, Dihexyl ether, and Dioctyl ether
Ester R¹COOR², wherein R¹ and R² are each independently CₓH₂ₓ₊₁(x≥1): For example, Butyl valerate, Butyl hexanoate, Butyl octanoate, Pentyl valerate, Propyl butyrate, Propyl hexanoate, Hexyl hexanoate, and Hexyl octanoate.

In certain embodiments, the surface protection layer forms a continuous layer of uniform thickness on the SSE surface. In certain embodiments, the layer has a thickness of ≥0.1 nm.

The surface protection layer can be removed by subjecting the coated SSE to a temperature of 20 to 600, more particularly 20 to 150° C., for 1 minute to 120 minutes, more particularly 10 minutes to 60 minutes.

The surface protection can be applied to any SSE. Preferably, the SSE is an air-stable SSE, particularly SSEs having high ionic conductivity (>1 mS/cm) at room temperature, high chemical stability with O₂, N₂, and CO₂ in the air, and high chemical stability against water in the air with a limited generation of H₂S (<10 ppm within 2 hours, under relative humidity <15%).

In certain embodiments, the SSE is Li₇P₂S₈X, wherein X is Cl, Br, I, and/or F. The halide doping enables tuning of the crystalline structure and bonding strength to enhance the Li⁺ conductivity and chemical stability against Li metal and moisture.

In certain embodiments, the SSE is Li₃PS₄ (LPS) or Li₁₀GeP₂S₁₂ (LGPS).

In other embodiments, the protective coating can be applied to moisture sensitive Li-ion conductors (sulfides and oxides) and active electrode materials (e.g. LiNi_{0.8}Co_{0.1}Mn_{0.1}O₂).

In certain embodiments, the sulfide—containing SSEs have a room-temperature Li⁺ conductivity >5 mS/cm or >1 mS/cm, and a Li/SSE interfacial resistance <5 Ωcm². In certain embodiments, the SSE is an ultra—thin solid film (10-30 μm).

The surface protection agent may be applied to the SSE surface by any method. For example, the surface protection agent may be applied to the SSE surface via physical stir-mixing, spraying, chemical vapor deposition, molecular layer deposition, and/or atomic layer deposition. In certain embodiments, the surface protection agent is a liquid that is mixed with SSE particles. The SSE particles may have, for instance, an average particle diameter of 10 nm-100 μm. The surface protection agent/SSE particle mixture is heated under conditions sufficient for depositing the surface protection agent onto the SSE particle surface. For example, the surface protection layer can be deposited onto SSE particle surfaces by stir-mixing the surface protection agent and SSEs at a temperature of 0 to 200, more particularly 20 to 80° C., for 1 min to 120 min, more particularly 10 min to 60 min.

The SSE may be included in an electrochemical cell includes the cathode, an anode, an electrolyte, and a separator positioned between the anode and the cathode. The cell may be assembled into a lithium-ion battery system.

Illustrative cathode materials include intercalated lithium, a metal oxide (for example, a lithium-containing oxide such as a lithium cobalt oxide, a lithium iron phosphate, a lithium magnesium oxide, a lithium nickel manganese cobalt oxide, or a lithium nickel cobalt aluminum oxide), or graphene.

In any of the foregoing or following embodiments, the cathode may further comprise one or more inactive materials, such as binders and/or additives (e.g., carbon). In some embodiments, the cathode may comprise from 0-10 wt %, such as 2-5 wt % inactive materials. Suitable binders include, but are not limited to, polyvinyl alcohol, polyvinyl fluoride, ethylene oxide polymers, polyvinylpyrrolidone, polyurethane, polytetrafluoroethylene, polyvinylidene fluoride, polyethylene, polypropylene, styrene-butadiene rubber, epoxy resin, nylon, polyimide and the like. Suitable conductive additives include, but are not limited to, carbon black, acetylene black, Ketjen black, carbon fibers (e.g., vapor-grown carbon fiber), metal powders or fibers (e.g., Cu, Ni, Al), and conductive polymers (e.g., polyphenylene derivatives).

In any of the foregoing or following embodiments, the anode may be any anode suitable for a lithium ion battery. In some embodiments, the anode is lithium metal, lithium-metal alloy (for example, a lithium-metal alloy with Li atomic percentage of 0.1-99.9%, such as Li—Mg, Li—Al, Li—In, Li—Zn, Li—Sn, Li—Au, Li—Ag), graphite, an intercalation material, or a conversion compound. The intercalation material or conversion compound may be deposited onto a substrate (e.g., a current collector) or provided as a free-standing film, typically, including one or more binders and/or conductive additives. Suitable binders include, but are not limited to, polyvinyl alcohol, polyvinyl chloride, polyvinyl fluoride, ethylene oxide polymers, polyvinylpyrrolidone, polyurethane, polytetrafluoroethylene, polyvinylidene fluoride, polyethylene, polypropylene, styrene-butadiene rubber, epoxy resin, nylon, polyimide and the like. Suitable conductive additives include, but are not limited to, carbon black, acetylene black, Ketjen black, carbon fibers (e.g., vapor-grown carbon fiber), metal powders or fibers (e.g., Cu, Ni, Al), and conductive polymers (e.g., polyphenylene derivatives). Exemplary anodes for lithium batteries include, but are not limited to, lithium metal, carbon-based anodes (e.g., graphite, silicon-based anodes (e.g., porous silicon, carbon-coated porous silicon, carbon/silicon carbide-coated porous silicon), Mo₆S₈, TiO₂, V₂O₅, Li₄Mn₅O₁₂, Li₄Ti₅O₁₂, C/S composites, and polyacrylonitrile (PAN)—sulfur composites. In some embodiments, the anode is lithium metal.

In any of the foregoing or following embodiments, the separator may be glass fiber, a porous polymer film (e.g., polyethylene- or polypropylene-based material) with or without a ceramic coating, or a composite (e.g., a porous film of inorganic particles and a binder). One exemplary polymeric separator is a Celgard® K1640 polyethylene (PE) membrane. Another exemplary polymeric separator is a Celgard® 2500 polypropylene membrane. Another exemplary polymeric separator is a Celgard® 3501 surfactant-coated polypropylene membrane.

The surface protective-coated SSE can be assembled with a cathode, an anode, and optionally a separator into an electrochemical cell.

A SSE structure (e.g., a thin film) can be fabricated from the protective agent-coated particles by any suitable method.

In one method the protective agent-coated SSE particles are pelletized directly with a pressing die at 100-650 MPa to form an SSE pellet.

In another method for SSE thin film fabrication, 1%-99 wt % of polymeric binder is mixed with the protective agent-coated SSE particles to form a slurry and then is casted to form SSE thin film with the thickness in the range of 2-300 um.

In a further method 1%-99 wt % of polymeric binder is dry mixed with the protective agent-coated SSE particles and then dry processed into SSE thin film with the thickness in the range of 2-300 um. The whole process is protected under the Ar gas.

A cell can be assembled from the protective agent-coated SSEs by any suitable method.

In one method the protective agent-coated SSE particles are pelletized with a pressing die at 100-650 MPa to form an SSE pellet. A mixture of cathode powders, agent-coated SSE particles, and carbon conductors is spread on the top of the SSE pellet and pressed together with SSE pellet under 100-650 MPa. Then Li metal, Li-alloy, or other anode materials is pressed on the other side of SSE pellet under ₁₀₀—₆₅₀ MPa to form a cell.

In a method for SSE thin film fabrication, 1%-99 wt % of polymeric binder is mixed with the protective agent-coated SSE particles to form a slurry and then is casted to form SSE thin film with the thickness in the range of 2-300 um. For cathode film fabrication, 1%-99 wt % of binder is mixed with the cathode active materials, agent-coated SSE particles, and carbon additives, and then is casted to form cathode film with the thickness in the range of 2-300 um. Cathode film, SSE film, and Li metal, Li-alloy or other anodes are sandwitched and pressed together under 100-650 MPa to form a cell.

In another method for SSE thin film fabricatoin, 1%-99 wt % of polymeric binder is dry mixed with the protective agent-coated SSE particles and then dry processed into SSE thin film with the thickness in the range of 2-300 um. For the cathode film fabrication, 1%-99 wt % of binder is dry mixed with the cathode active materials , agent-coated SSE particles, and carbon additives, and then is processed into cathode film with the thickness in the range of 2-300 um. Cathode film, SSE film, and Li metal, Li-alloy or another anode material are sandwitched and pressed together under 100-650 MPa to form a cell. The whole process is protected under the Ar gas.

At the last step of pressing cathode, SSE, and Li/Li-alloy/other anode together, heat the whole cell to remove the protective coating layer before the cell is vacuum-sealed in package materials.

### EXAMPLES

### Reversible Surface Modification of SSE with 1-Bromopentane

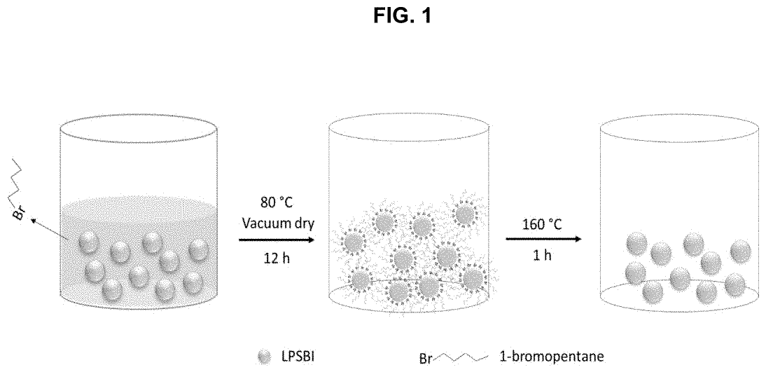

A typical process of amphipathic molecule coating and releasing onto/from the SSEs is illustrated in FIG. 1. Sulfide SSE powders were immersed into liquid organic 1-Bromopentane, followed by vacuum drying at 80° C. for 12 hrs to obtain the 1-Bromopentane coated SSE (LPSBI—Bromo). 1-Bromopentane molecules self-assembled on SSE surfaces via Van der Waals force interaction between the Br of 1-Bromopentane and S from SSE. The hydrophobic and long chain alkyl tails —(CH₂)ₓ—CH₃ shield SSE surfaces from water molecules attacking the SSE material. The coated 1-Bromopentane layers can be released from the SSE surface by heat treatment at 160° C. for 1h (LPSBI-Bromo-160).

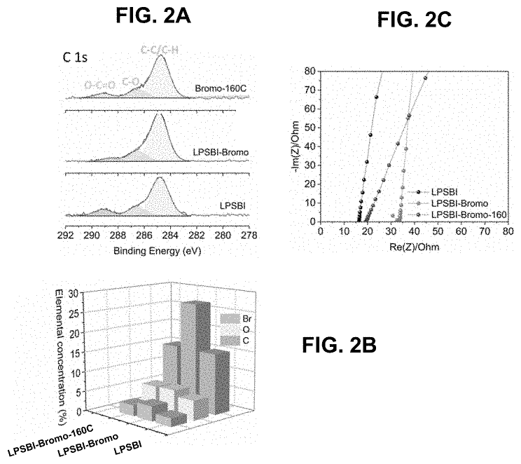

To study changes of SSE surface properties before and after 1-Bromopentane coating, X-ray photoelectronic spectra (XPS) analysis was carried out on the pristine LPSBI, LPSBI-Bromo, and LPSBI-Bromo-160 powders. FIGS. 2A and 2B show the high-resolution C is spectra of these three powders and the variations of Br and C in atomic concentrations upon coating/releasing of 1-Bromopentane, respectively. For pristine LPSBI, peaks with binding energies at 284.8, 286.7, and 289.1 eV were attributed to C—H/C—C, C—O, and O—C═O groups, respectively. Those carbon signal could be from the absorbed organic species in glovebox or carbon residual in the XPS chamber. After being treated with 1-Bromopentane, LPSBI-Bromo showed a suppressed O—C═O peak while increased C—H/C—C peak, indicating SSE surface was covered by C—H/C—C rich species, which is 1-Bromopentane. This conclusion is supported by quantitative analysis of atomic concentrations of C and Br. As shown in FIG. 1B, upon attaching 1-Bromopentane in LPSBI-Brom, atomic concentration of C jumped from 15.24% to 26.90%, while Br increasing from 2.13% to 3.72%. The measured C/Br ratio in the detecting area is about 7:1, which was close to the ratio of 5:1 in 1-bromopentane (C₅H₁₁Br), confirming the presence of C₅H₁₁Br on the surface of LPSBI. The higher C/Br ratio of 7:1 could be due to pre-existing carbon species on the surface of LPSBI. After heating LPSBI-Bromo at 160° C. for 1 h, C 1 s spectrum of LPSBI-Bromo-160 agreed well with that for pristine LPSBI. Atomic concentrations of C and Br dropped back to the values comparable to pristine LPSBI (FIG. 2B), indicating that 1-bromopentane can be released from LPSBI's surface.

### Thickness of 1-Bromopentane Interphase on the Surface of SSEs

The thickness of 1-Bromopentane interphase was calculated based on the molecular size and density of 1-Bromopentane, mass change of LPSBI before and after treated with 1-Bromopentane, and Brunauer-Emmett-Teller (BET) surface area. The molecular length of 1-Bromopentane is about 0.75 nm. Density of 1-Bromopentane is 1.2 g cm⁻³. BET surface area of LPSBI is ˜10 m² g⁻¹. After treated with 1-Bromopentane, 1 g of LSPBI gained ˜9.7 mg in mass, which is convert to nearly a single layer of 1-Bromopentane molecules on the surface of LSPBI particles. A more detailed picture of the interaction between 1-Bromopentane and LPSBI can be obtained from XPS. After absorption, we find a decrease in the intensity of the LPSBI substrate signals Li 1 s, P 2 p, and S 2 p, from which we can estimate the adsorption layer thickness d according to:

$$d = ln ( \frac{{I}_{x , corr}}{{I}_{x , meas}} ) {λ}_{x} cosθ \qquad ( 1 )$$

where I_{x, corr} is the core level intensity of the element x in the LPSBI, I_{x, meas} is the intensity of the element x signal attenuated by the adsorbed layer, λₓ is the inelastic mean free path (IMFP) of x photoelectron in the adsorption overlayer, and θ is the emission angle relative to the sample normal. Using Equation 1, we calculated d=0.59 nm (±0.05 nm) for 1-bromopentane on LPSBI. Binding energies and peak shapes of the Li 1 s, P 2 p, and S 2 p signals remain the unchanged after monolayer adsorption. XPS results agree well with our thermalgravimetric analysis, confirming that it is monolayer adsorption of 1-bromopentane on the LPSBI.

FIG. 2D shows electrochemical impedance spectra (EIS) of pristine LPSBI, LPSBI-Bromo, and LPSBI-Bromo-160 samples at room temperature. All powder samples were pressed into pellets with diameter of 1 mm and thickness of 0.7 mm for EIS measurement. For pristine LPSBI, a straight line with an intersection value of 17 ohm at x-axis was detected in its spectrum, representing impedance contributions from blocking electrode. Compared to pristine LPSBI, rear section of a semicircle was observed in the high frequency range in the EIS of LPSBI-Bromo, which corresponded to Li-ion transport through grains and grain boundaries. The appearance of a semicircle in the EIS of LPSBI-Bromo rather than pristine LPSBI was due to the existence of coating of 1-Bromopentane with low Li-ion conductivity on the surface of LPSBI. After heating, the semicircle disappeared in the impedance spectrum of LPSBI-Bromo-160, indicating that the interphase was removed from LPSBI surface. Recovery of EIS further proves the reversible coating as observed in XPS characterization. The calculated ionic conductivities for pristine LPSBI, LPSBI-Bromo, and LPSBI-Bromo-160 were 5.3, 2.8, and 4.8 mS cm⁻¹, respectively. Combining XPS, EIS analysis, and ionic conductivity measurement, it is confirmed that 1-bromopentane was successfully coated on the surface of LPSBI and can be released reversibly without affecting the Li-ion transport properties.

### Moisture Stability of SSE Treated with 1-Bromopentane

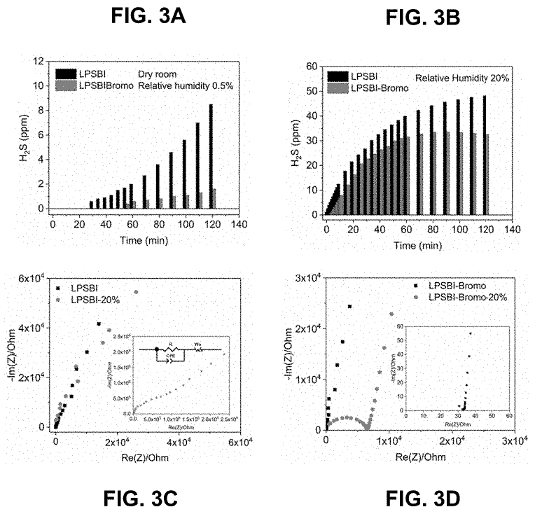

To investigate the effects of 1-Bromopentane coating on moisture stability of LPSBI, we monitored H₂S generation from the LPSBI and LPSBI-Bromo during exposure in dry room (R.H.=0.1%) and ambient (R.H.=20%) environments for 120 minutes (See set-up of the H₂S measurement in supporting information). As shown in FIG. 3A, the concentration of H₂S gas released from pristine LPSBI kept on increasing and reached the summit of 8.9 ppm after being exposed in dry room for 120 min. In sharp contrast, concentration of H₂S gas was as low as 1.6 ppm for LPSBI-Bromo during the 120 min exposure, which was 82% less than the amount from pristine LPSBI. The 1-Bromopentane coating almost shut down the reactions between LPSBI and H₂O, dramatically enhancing moisture stability of LPSBI. Even under ambient conditions with much higher R.H.=20%, the 1-Bromopentane coating still showed decent effectiveness on protecting LPSBI. In FIG. 3B, the concentration of H₂S gas releasing from pristine LPSBI rocketed to 48.6 ppm by the end of test. By contrast, the concentration of H₂S gas releasing from LPSBI-Bromo was much less, only with the peak value of 33.5 ppm after exposing for 80 min, the value remaining the same till the end of test. There results clearly shows that the 1-Bromopentane coating on the surface of LPSBI suppressed H₂S generation.

FIG. 3C shows the comparison of the EIS of LPSBI before and after exposure to air with R.H. of 20%. The EIS of LPSBI after exposure (LPSBI-20%) was analyzed by fitting to an equivalent electrical circuit composed of a constant phase element (CPE) in parallel with an ohmic resistance (R), representing impedance of Li ion transport through bulk/grain and grain boundary; and a Warburg impedance (W₀), representing impedance contributions from electrode. Upon exposure, a huge semicircle was detected in the EIS of LPSBI-20%, corresponding to large overall (bulk/grain and grain boundary) impedance, which was probably due to severe reactions between LPSBI and H₂O. The calculated ionic conductivity of LPSBI-20% was 5.5×10⁵ mS cm¹ at room temperature, 5 magnitudes lower than that for pristine LPSBI before exposure (5.3 mS cm⁻¹). In sharp contrast, a much smaller semicircle was identified in the EIS of LPSBI—Bromo-20% (LPSBI-Bromo after exposure to air with R.H. of 20%). The calculated ionic conductivity is 1.5×10⁻² mS cm⁻¹ at room temperature, which is 3 magnitudes higher than that for LPSBI-20%.

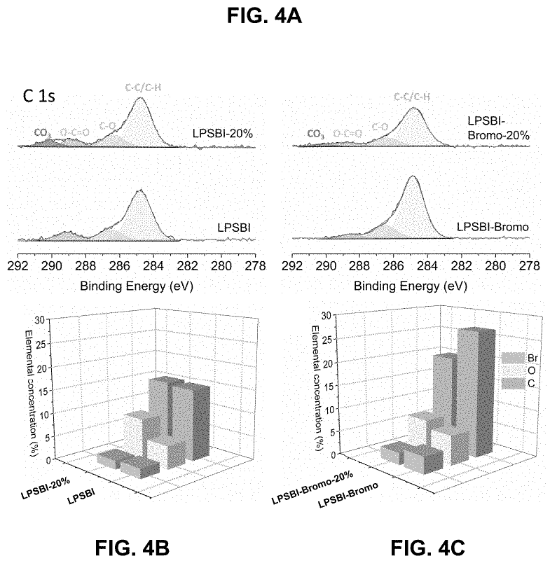

To study surface details of these samples before and after exposure, XPS measurements have been conducted on LPSBI, LPSBI-20%, LPSBI-Bromo, and LPSBI-Bromo-20% powders. FIG. 4A showed the high-resolution C is spectra of these powders. A new peak centered at ˜290.2 eV, corresponding to CO₃, was detected in LPSBI-20% compared to pristine LPSBI, indicating that carbonate species could be products of reaction between LPSBI and H₂O/CO₂ in air. It is also supported by the changes in atomic concentrations of C and O, as shown in FIG. 4B. The atomic concentration of C increased from 15.2% to 15.7%, while that of O jumping from 4.9% to 8.9%. The higher O/C ratio than that in CO₃ suggested that other O-rich species were also generated after air exposure. In sharp contrast, the intensity of CO₃ peak in LPSBI-Bromo-20% was remarkably lower. The concentration of O only increased from 6.4% to 8.0% after exposure, as shown in FIG. 4B, further showing that less severe reactions happened between LPSBI and H₂O/CO₂.

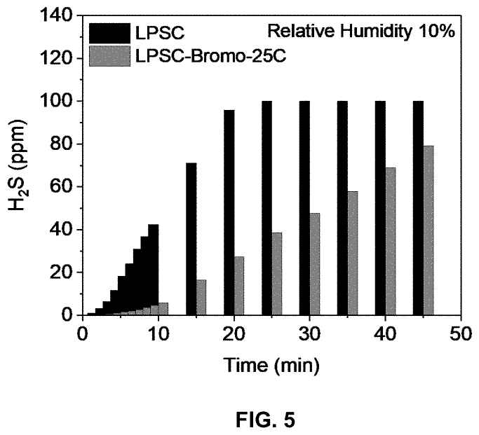

To investigate the effects of 1-Bromopentane coating on moisture stability of Li₆PS₅Cl (LPSC), we monitored H₂S generation from the LPSC and LPSC-Bromo-25C during the exposure in an ambient environment with R.H.=10% for 50 minutes. As shown in FIG. 5, the concentration of H₂S gas released from pristine LPSC kept on increasing and reached the summit of 100 ppm (limit of testing) after being exposed for 25 min. In sharp contrast, concentration of H₂S gas was as low as 40 ppm for LPSC-Bromo-25C during the 25 min exposure, which was 60% less than the amount from pristine LPSC. The 1-Bromopentane coating slows down the reactions between LPSC and H₂O, dramatically enhancing moisture stability of LPSC.

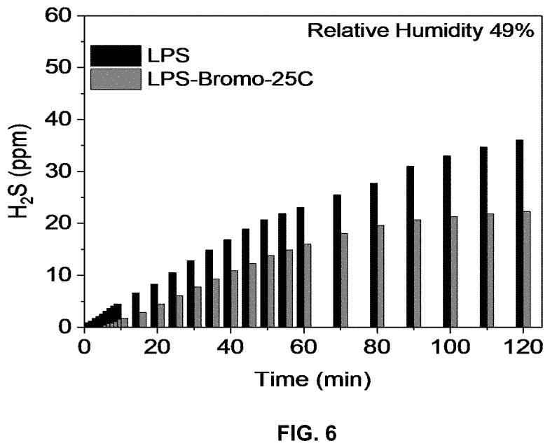

To investigate the effects of 1-Bromopentane coating on moisture stability of Li₃PS₄ (LPS), we monitored H₂S generation from the LPS and LPS-Bromo-25C during the exposure in an environment with R.H.=49% for 120 minutes. As shown in FIG. 6, the concentration of H₂S gas released from pristine LPS kept on increasing and reached the summit of 36 ppm after being exposed for 120 min. In sharp contrast, concentration of H₂S gas was as low as 20 ppm for LPS-Bromo-25C during the 120 min exposure. The 1-Bromopentane coating slows down the reactions between LPS and H₂O, dramatically enhancing moisture stability of LPS.

### Methods

Preparation of solid-state electrolytes. Glass-ceramic Li₇P₂S₈Br_{0.5}I_{0.5} was prepared by ball-mill technic followed but low-temperature heat treatment. The stoichiometric amounts of Li₂S (Sigma-Aldrich, anhydrous, 99%), P₂S₅ (Sigma-Aldrich, 99%), LiBr (Sigma-Aldrich, 99.99%), and LiI (Sigma-Aldrich, 99.99%) were hand-ground before transferring to a zirconium oxide grinding jar. The mixture was ball-milled for 40 h at a speed of 600 rpm using a planetary ball mill (RETSCH PM 100 Planetary Ball Mill). The obtained powders were heated at 160° C. for 1 hour. The whole process was under Argon atmosphere protection. Glass ceramic Li₃PS₄ was prepared following the same ball mill method but heating at 243° C. for 2 h.

Surface modification. 1-bromopentane (Sigma-Aldrich, 98%) was dried with molecular sieve before use. 450 mg of each of Li₃PS₄, Li₇P₂S₈Br_{0.5}I_{0.5}, and Li₁₀GeP₂S₁₂ were mixed with 3 g 1-bromopentane for 8 h. The mixture was dried under vacuum at 80° C. overnight to obtain the final products. To release 1-bromopentane on the surface, solid-state electrolytes with surface treatment were heated at 160° C. for 1 h. All the processes were protected under Ar atmosphere. Moisture stability characterization. To monitor the amount of H₂S gas releasing from pristine and surface treated powder samples, 150 mg of each powder was sealed in a desiccator with volume of 7112 cm³, in which a calibrated gas detector (FORENSICS DETECTORS) and a humidity detector (ThermoPro) were used to detect the concentration of H₂S and relative humidity in detector, respectively. Dedicator was put in ambient environment with relative humidity of 20% and dry room with relative humidity of 0.5% one day prior to the test. XRD and Raman spectroscopies. Powder XRD measurements were performed on a Rigaku Miniflex II spectrometer with Cu Kα radiation, using XRD holder with beryllium window (Rigaku Corp.) for air sensitive samples.

SEM and TEM characterization. Morphologies of SSE powders were observed on a scanning electron microscope (JSM-IT-200, JOEL)
Electrochemical measurement. The Li-ion conductivity of the SSE was measured by electrochemical impedance spectroscopy using Biologic SP 200 over a 7 MHz to 0.1 Hz frequency range with an amplitude of 5 mV. SSE pellet was prepared by pressing powders under the pressure 400 MPa, where carbon-coated aluminum foils were attached on both faces of pellets, serving as blocking electrodes.

In view of the many possible embodiments to which the principles of the disclosed invention may be applied, it should be recognized that the illustrated embodiments are only preferred examples of the invention and should not be taken as limiting the scope of the invention.

What is claimed is:

1. A method comprising:
contacting an amphipathic surface protective agent with a moisture sensitive Li-ion conductor material surface resulting in a protected Li-ion conductor material, and
assembling an electrochemical cell that includes the protected Li-ion conductor material.

2. The method of claim 1, wherein the Li-ion conductor material is a sulfide-containing solid-state electrolyte material.

3. The method of claim 1, wherein the amphipathic surface protective agent includes a hydrophilic head selected from —OH; —C(O)O—; —C═O—; —NH—; —Alₙ(OH)ₘ, wherein n≥1 and m≥1; —PO₄—; —C(O)NH₂; —NH₂; —OSO₃H; —SO₃H; —SH; —Cl; —Br; —I; and —NR₄⁺, wherein R is CₓH₂ₓ₊₁, x≥1; and a hydrophobic tail selected from —CH₃; —CH₂—CH₃; —R—C₆H₅, wherein R is CₓH₂ₓ₊₁, x≥1; —CH═CH₂; -C₃-C₅₀ alkyl or substituted alkyl; -C₃-C₅₀ alkenyl or substituted alkenyl; -C₃-C₅₀ alkynyl or substituted alkynyl; (CH₂)ₙ(n≥2); —CH₂F; —CHF₂; —CF₃; (CF₂)ₙ(n≥2); and (Si(CH₃)₂—O—)ₙ(n≥2).

4. The method of claim 1, wherein the amphipathic surface protective agent has a hydrophilic head selected from —SH, —Cl, —Br, or —I; and a -C₃-C₅₀ alkyl or substituted -C₃-C₅₀ alkyl hydrophobic tail.

5. The method of claim 1, wherein the amphipathic surface protective agent is CₓH₂ₓ₊₁Br (x≥1); CₓH₂ₓ₊₁Cl (x≥1); CₓH₂ₓ₊₁I (x≥1); CₓH₂ₓ₊₁SH (x≥1); R¹OR², wherein R¹ and R² are each independently CₓH₂ₓ₊₁(x≥1); R¹COOR², wherein R¹ and R² are each independently CₓH₂ₓ₊₁(x≥1); or a mixture thereof.

6. The method of claim 2, wherein the amphipathic surface protective agent is 1-bromopentane.

7. The method of claim 2, wherein the sulfide-containing solid-state electrolyte material is Li₇P₂S₈X, wherein X is Cl, Br, I, and/or F.

8. The method of claim 2, wherein the sulfide-containing solid-state electrolyte material is Li₃PS₄ or Li₁₀GeP₂Si₁₂.

9. The method of claim 5, wherein the sulfide-containing solid-state electrolyte material is Li₇P₂S₈X, wherein X is Cl, Br, I, and/or F; Li₃PS₄; or LiioGeP₂Si₂

10. The method of claim 2, wherein assembling the electrochemical cell comprises forming the sulfide-containing solid-state electrolyte, forming a cathode, and forming an anode, wherein the sulfide-containing solid-state electrolyte is interposed between the anode and the cathode.

11. A method comprising:
coating an amphipathic surface protective agent onto a surface of a sulfide-containing solid-state electrolyte material.

12. The method of claim 11, further comprising processing the coated sulfide-containing solid-state electrolyte material and subsequently removing the coating from the coated sulfide-containing solid-state electrolyte material.

13. The method of claim 11, wherein the amphipathic surface protective agent has a hydrophilic head selected from —SH, —Cl, —Br, or —I; and a -C₃-C₅₀ alkyl or substituted -C₃-C₅₀ alkyl hydrophobic tail.

14. The method of claim 11, wherein the amphipathic surface protective agent is CₓH₂ₓ₊₁Br (x≥1); CₓH₂ₓ₊₁Cl (x≥1); CₓH₂ₓ₊₁I (x≥1); CₓH₂ₓ₊₁SH (x≥1); R¹OR², wherein R¹ and R² are each independently CₓH₂ₓ₊₁(x≥1); R¹COOR², wherein R¹ and R² are each independently CₓH₂ₓ₊₁(x≥1); or a mixture thereof.

15. The method of claim 11, wherein the amphipathic surface protective agent is 1-bromopentane.

16. The method of claim 11, wherein the sulfide-containing solid-state electrolyte material is Li₇P₂S₈X, wherein X is Cl, Br, I, and/or F.

17. The method of claim 11, wherein the sulfide-containing solid-state electrolyte material is Li₃PS₄ or Li₁₀GeP₂S₁₂.

18. The method of claim 11, wherein the sulfide-containing solid-state electrolyte material is Li₇P₂S₈X, wherein X is Cl, Br, I, and/or F; Li₃PS₄; or Li₁₀GeP₂S₁₂.

19. A material comprising a sulfide-containing solid-state electrolyte coated with an amphipathic surface protective agent, wherein the amphipathic surface protective agent includes a hydrophilic head selected from —OH; —C(O)O—; —C═O—; —NH—; —Alₙ(OH)ₘ, wherein n≥1 and m≥1; —PO₄—; —C(O)NH₂; —NH₂; —OSO₃H; —SO₃H; —SH; —Cl; —Br; —I; and —NR₄⁺, wherein R is CₓH₂ₓ₊₁, x≥1; and a hydrophobic tail selected from —CH₃; —CH₂—CH₃; —R—C₆H₅, wherein R is CₓH₂ₓ₊₁, x≥1; —CH═CH₂; -C₃-C₅₀ alkyl or substituted alkyl; -C₃-C₅₀ alkenyl or substituted alkenyl; -C₃-C₅₀ alkynyl or substituted alkynyl; (CH₂)ₙ(n≥2); —CH₂F; —CHF₂; —CF₃; (CF₂)ₙ(n≥2); and (Si(CH₃)₂—O—)ₙ(n≥2).

20. The material of claim 19, wherein the sulfide-containing solid-state electrolyte material is Li₇P₂S₈X, wherein X is Cl, Br, I, and/or F; Li₃PS₄; or Li₁₀GeP₂S₁₂, and the amphipathic surface protective agent is wherein the amphipathic surface protective agent is CₓH₂ₓ₊₁Br (x≥1); CₓH₂ₓ₊₁Cl (x≥1); CₓH₂ₓ₊₁I (x≥1); CₓH₂ₓ₊₁SH (x≥1); R¹OR², wherein R¹ and R² are each independently CₓH₂ₓ₊₁(x≥1); R¹COOR², wherein R¹ and R² are each independently CₓH₂ₓ₊₁(x≥1); or a mixture thereof.

21. The material of claim 19, wherein the material is in a film shape.

22. The material of claim 19, wherein the material is in particle form.

23. The material of claim 19, wherein the material is a pellet.

24. A construct comprising:
a sulfide-containing solid-state electrolyte coated with an amphipathic surface protective agent, wherein the amphipathic surface protective agent includes a hydrophilic head selected from —OH; —C(O)O—; —C═O—; —NH—; —Alₙ(OH)ₘ, wherein n≥1 and m≥1; —PO₄—; —C(O)NH₂; —NH₂; —OSO₃H; —SO₃H; —SH; —Cl; —Br; —I; and —NR₄⁺, wherein R is CₓH₂ₓ₊₁, x≥1; and a hydrophobic tail selected from —CH₃; —CH₂—CH₃; —R—C₆H₅, wherein R is CₓH₂ₓ₊₁, x≥1; —CH═CH₂; -C₃-C₅₀ alkyl or substituted alkyl; -C₃-C₅₀ alkenyl or substituted alkenyl; -C₃-C₅₀ alkynyl or substituted alkynyl; (CH₂)ₙ(n≥2); —CH₂F; —CHF₂; —CF₃; (CF₂)ₙ(n≥2); and (Si(CH₃)₂—O—)ₙ(n≥2);
a cathode material; and
an anode material.

25. The construct of claim 24, wherein the construct is a pellet.

26. The construct of claim 24, wherein the electrolyte is interposed between the cathode material and the anode material.

27. The construct of claim 24, wherein a film comprising the electrolyte is interposed between a film comprising the cathode material and a film comprising the anode material.
